(19) United States
(12) Patent Application Publication
(10) Pub. No.: US 2009/0113319 A1
(43) Pub. Date: Apr. 30, 2009

(54) DEVELOPING USER PROFILES IN VIRTUAL WORLDS

(76) Inventors: Christopher J. Dawson, Arlington, VA (US); Rick A. Hamilton, II, Charlottesville, VA (US); Michael D. Kendzierski, New York, NY (US); James W. Seaman, Falls Church, VA (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/928,852

(22) Filed: Oct. 30, 2007

(51) Int. Cl. G06F 3/00

(52) U.S. Cl. 715/762

(57) ABSTRACT

Methods and arrangements of developing user profiles in virtual worlds are discussed. Embodiments include transformations, code, state machines or other logic to receive data from a software agent in a virtual world, directly or indirectly. The data may be based upon information automatically gathered from data stores outside the virtual world, including account data and user profile data. The embodiment may also involve developing a user profile of the user in the virtual world, based upon the data received from the software agent. An embodiment may also involve automatically gathering information from data stores external to the virtual world. The information may include user account data and user profile information. The embodiment may also include aggregating data for generating the user profile in the virtual world, based upon the information; and transmitting the data directly or indirectly to the virtual world.

### FIELD

The present invention is in the field of virtual worlds. More particularly, the present invention relates to methods and arrangements to create or modify user profiles in virtual worlds based upon automatically gathered information external to the virtual worlds.

### BACKGROUND

A virtual world is a computer-based simulated environment. The environment may resemble the real world, with real world rules such as gravity, topography, and locomotion; and with social and economic interactions between characters. The character of a user may be represented as an avatar, a two or three-dimensional graphical representation. Many virtual worlds allow for multiple users and provide for communications between the users. Virtual worlds may be used for massively multiple player online role-playing games, for social or business networking, or for participation in imaginary social or business universes.

Virtual worlds may provide a useful environment for personal interactions, both business and social. Avatars in virtual worlds may undergo a wide range of business and social experiences, and such experiences are becoming more important as business and social transactions are becoming common in virtual worlds. In fact, the characteristics of an avatar may play important social, business, and other related roles in virtual worlds. One example is Second Life (SL), a privately owned 3-D virtual world, made publicly available in 2003 by Linden Lab. The SL virtual world is computed and managed by a large array of servers that are owned and maintained by Linden Lab. The SL client program provides its users, referred to as residents, with tools to view, navigate, and modify the SL world and participate in its virtual economy. In 2006, SL had over one million residents. Social and business interactions are important in SL, and these interactions include resident interactions in both personal and business meetings.

Registering or modifying a registration in a virtual world may be laborious and confusing. The registration process may require a user to manually enter a considerable amount of information. The information may include account information about the user, such as a real name, user name, email address and physical address; or other profile information such as a description of the user's interests, a brief biography, and the user's choice of parameters for the virtual world. In addition, a user with limited knowledge of virtual worlds may not know how to register for them and access them easily.

The user may have already provided the same or similar information in creating user profiles outside the virtual world environment. The user may have already invested time and effort entering profiles in web sites such as other virtual world sites, legacy social network sites, blogs; and in other applications such as an email or instant message programs. It may be laborious for the user to manually recreate all of the information that the user has already entered in other user profiles.

### SUMMARY OF THE INVENTION

The problems identified above are in large part addressed by methods and arrangements of developing user profiles in virtual worlds. One embodiment provides a method of developing user profiles in virtual worlds. The embodiment may involve automatically gathering information from data stores external to the virtual world. The information may include user account data and user profile information. The embodiment may also include aggregating data for generating the user profile in the virtual world, based upon the information; and transmitting the data directly or indirectly to the virtual world.

The embodiment may also involve directly or indirectly receiving data from a software agent in a virtual world. The data may be based upon information automatically gathered from data stores outside the virtual world via the software agent, including account data and user profile data. The embodiment may also involve developing a user profile of the user in the virtual world, based upon the data received from the software agent.

### BRIEF DESCRIPTION OF THE DRAWINGS

Advantages of the invention will become apparent upon reading the following detailed description and upon reference to the accompanying drawings in which like references may indicate similar elements:

FIG. 1 depicts an embodiment of a networked system of devices capable of developing user profiles in virtual worlds;

FIG. 2 depicts an embodiment of a computer capable of developing user profiles in virtual worlds;

FIG. 3A depicts an embodiment of an apparatus to automatically gather information for developing user profiles in virtual worlds;

FIG. 3B depicts a virtual world capable of developing user profiles based upon information automatically gathered from sources external to the virtual world;

FIG. 4 depicts a flowchart of an embodiment of a method to develop user profiles in virtual worlds based upon automatically gathered data;

FIG. 5 depicts an embodiment of data structures to develop a user profile in a virtual world on the basis of automatically gathered information; and

FIG. 6 depicts an embodiment of a data flow to develop a user profile in a virtual world on the basis of automatically gathered information.

### DETAILED DESCRIPTION OF EMBODIMENTS

The following is a detailed description of embodiments of the invention depicted in the accompanying drawings. The embodiments are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods and arrangements of developing user profiles in virtual worlds are contemplated. Embodiments include transformations, code, state machines or other logic to receive data from a software agent in a virtual world, directly or indirectly. The data may be based upon information automatically gathered from data stores outside the virtual world, including account data and user profile data. The embodiment may also involve developing a user profile of the user in the virtual world, based upon the data received from the software agent. Developing a user profile for a user may include creating a new user profile for the user and modifying an existing user profile for the user.

An embodiment may also involve automatically gathering information from data stores external to the virtual world. The information may include user account data and user profile information. The embodiment may also include aggregating data for generating the user profile in the virtual world, based upon the information; and transmitting the data directly or indirectly to the virtual world.

While specific embodiments will be described below with reference to particular circuit or logic configurations, those of skill in the art will realize that embodiments of the present invention may advantageously be implemented with other substantially equivalent configurations.

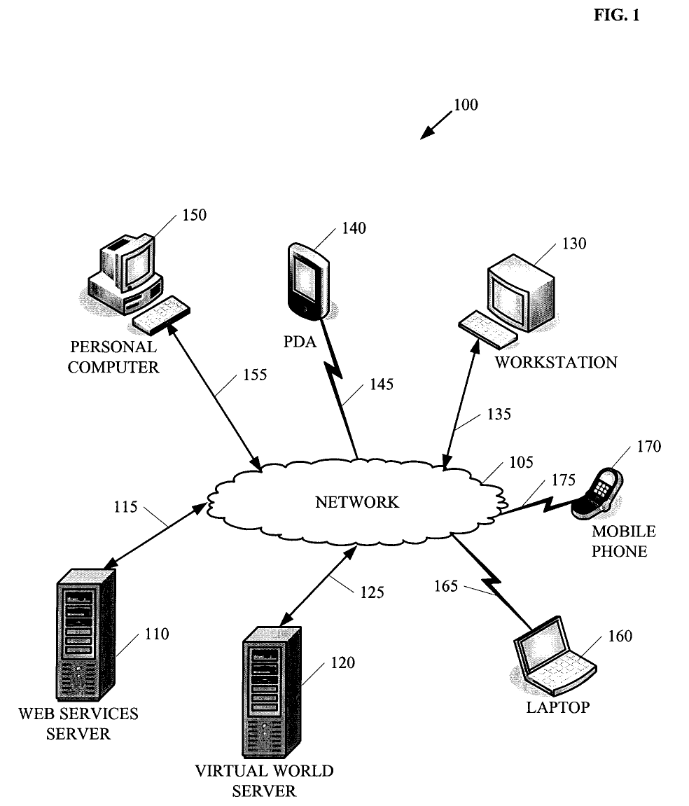

FIG. 1 depicts a diagram of an embodiment of a networked system 100 of devices capable of developing user profiles in virtual worlds. The system 100 includes a network 105, web services server 110 connected to network 105 through wireline connection 115, virtual world server 120 connected to network 105 through wireline connection 125, and a variety of computing devices capable of developing user profiles in virtual worlds, including:
workstation 130, a computer coupled to network 105 through wireline connection 135,
personal digital assistant 140, coupled to network 105 through wireless connection 145,
personal computer 150, coupled to network 105 through wireline connection 155,
laptop computer 160, coupled to network 105 through wireless connection 165; and
mobile phone 170, coupled to network 105 through wireless connection 175.

The devices 130, 140, 150, 160, and 170 may automatically gather information from data stores external to a virtual world for use in creating or modifying user profiles. The information may include user account information and user profile information. The devices may aggregate the information and transform it into data in a standard format, such as XML. The devices may transmit the data over the Internet or another wide area network directly to a virtual world implemented by virtual world server 120 or a web service implemented by web services server 110. The recipient of the data may develop user profiles based upon the data.

Network 105, which may consist of the Internet or another wide area network, a local area network, or a combination of networks, may provide data communications among web services server 110, virtual world server 120, and the devices 130, 150, 140, 160, and 170.

Web services server 110 may have installed and operative upon it software to perform web services. Web services present a standardized way of integrating web-based applications. Web services typically provide business services upon request through data communications in standardized formats called bindings. A binding is a specification of a data encoding method and a data communications protocol. The most common binding in use for web services is data encoding in XML according to the SOAP protocol and data communications with HTTP. SOAP (Simple Object Access Protocol) is a request/response messaging protocol that supports passing structured and typed data using XML and extensions.

Web services are often delivered by use of multi-node transactions carried out through the use of web services intermediaries. Web services intermediaries are web services components, typically a server, that lie between a web services requester and a web services ultimate destination server that delivers the web service. Intermediaries operate generally by intercepting a request from a client, optionally providing intermediary services, and then forwarding the request to an ultimate destination web services provider.

Web services server 110 may receive from one of the devices 130, 140, 150, 160, and 170 a request to create or modify (develop) a user profile in the virtual world maintained by virtual world server 120. The request may contain the data automatically gathered by the device for use in developing a user profile. Web services server 110 may process the request, acting as an intermediary between the user and the virtual world.

Virtual world server 120 may have installed and operative upon it software to implement a virtual world. A virtual world is a computer-based simulated environment. The environment may resemble the real world, with real world rules such as gravity, topography, and locomotion. Users may be represented by two or three-dimensional graphical representations called avatars. Many, but not all, virtual worlds allow for multiple users. Avatars may communicate by text or by real-time voice communication using VOIP. Virtual world are often used in massively multiplayer online role-playing games such as EverQuest, Ultima Online, Lineage, World of Warcraft, or Guild Wars. Other virtual worlds provide for simulated economic and social interaction in environments where the focus is more on the participation and less on winning and losing. These virtual worlds include Active Worlds, There, Second Life, Entropia Universe, The Sims Online, Kaneva, and Weblo. Still other virtual worlds, such as Friendster or MySpace, may provide a social networking experience. A user may enter some virtual worlds to share favorite blogs or other web sites with other participants.

The arrangement of web services server 110, virtual world server 120 and other devices making up the exemplary system 100 illustrated in FIG. 1 is for explanation, not for limitation. Data processing systems useful according to various embodiments of the present invention may omit a server, or may include additional servers, routers, other devices, and peer-to-peer architectures, not shown in FIG. 1, as will occur to those of skill in the art. In some embodiments, a computing device such as one of devices 130, 150, 140, 160, and 170 may communicate directly with a virtual world server device, without using a web service such as web service server 110 as an intermediary. In some other embodiments, there may be multiple web services intermediary between a user's computing device and a virtual world. In many other embodiments, programs other than web services may act as an intermediary.

Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

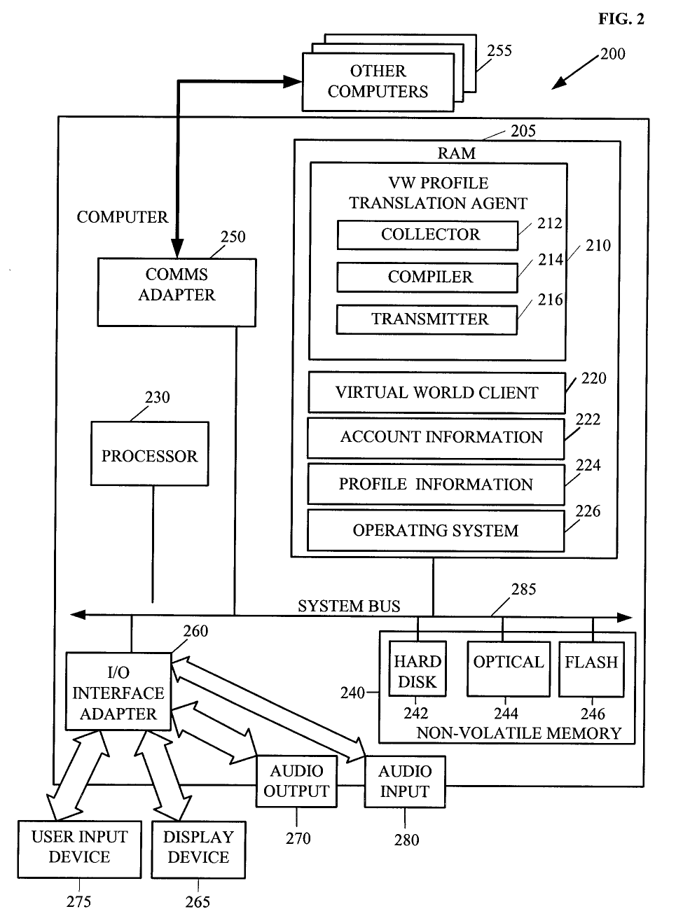

Turning to FIG. 2, depicted is an embodiment of a computer 200 capable of developing user profiles in virtual worlds that includes random access memory (RAM) 205, a processor 230 or CPU, non-volatile memory 240, a communications adapter 250, and an Input/Output (I/O) interface adapter 260 connected by system bus 285. Stored in RAM 205 is virtual world profile translation agent 210, virtual world client 220, account information 222, profile information 224, and operating system 226.

Virtual world profile translation agent 210 may comprise computer program instructions to process information, such as user account information and user profile information, for developing user profiles in virtual worlds. Virtual world profile translation agent 210 includes collector 212, compiler 214, and transmitter 216. Collector 212 may automatically gather information from data stores external to a virtual world. A data store is a source of the user's data, such as user profile information from other virtual worlds and social networks, and account information from email, blogs, and instant message accounts. A data store may include web history, cookies, social networking websites, and spider history. A data store may be maintained by a program other than virtual world programs, such as an email program or a web browser.

Compiler 214 may aggregate data based upon the information gathered by collector 212. The aggregating may include selecting data from the gathered information and placing it into a uniform format. The format may consist of XML, plain text, or another form of representation. The data for a user may be collected into information for a single profile or information for multiple files.

Transmitter 216 may transmit the data produced by compiler 214. The transmission may be sent directly to the virtual world, or may be sent to an intermediary, such as a web service, for further processing. Virtual world client 220 may comprise computer program instructions for interacting with a virtual world. Virtual world client 220 may transmit user input to the virtual world, and may process transmissions from the virtual world for output on a device such as display device 265 or audio output 270.

Account information 222 may contain information from accounts of a user, such as a login name, email address, and telephone numbers for an email account. Profile information 224 may contain user profile information of a user in a virtual world or other web site. A user profile in a virtual world contains information to manage a user's account, such as a user name, choice of avatar, interests, virtual world preferences, artifacts in the home environment, and friends' list.

Operating system 226 may comprise UNIX™, Linux™, Microsoft Windows™, AIX™, IBM's i5/OS™, or other operating systems useful for developing user profiles in virtual worlds as will occur to those of skill in the art. Virtual world profile translation agent 210, virtual world client 220, account information 222, profile information 224, and operating system 226 (components of software) are shown in RAM 205 in FIG. 2, but many components of such software may be stored in non-volatile memory 240 also. Further, while the components of such are shown simultaneously present in RAM, in some other embodiments, only some of the components of RAM 205 may be present at any given time.

The modules shown in RAM 205 are for explanation, not for limitation. In many other embodiments, virtual world profile translation agent 210 may constitute a component of virtual world client 220. In some embodiments, a virtual world client may be omitted. For example, a user may interact with a virtual world through a web browser.

Non-volatile computer memory 240 may be implemented as a hard disk drive 242, optical disk drive 244, electrically erasable programmable read-only memory space (EEPROM or Flash memory) 246, RAM drives (not shown), or as any other kind of computer memory as will occur to those of skill in the art. Communications adapter 250 may implement the hardware level of data communications between computer 200 and other computers, such as other computers 255. The data communications may occur directly or through a network and may include communicating with a virtual world server or web service server. Such data communications may be carried out through serially through RS-232 connections, through external buses such as USB, through data communications networks such as IP networks, and in other ways as will occur to those of skill in the art. Examples of communications adapters include modems for wired dial-up communications, Ethernet (IEEE 802.3) adapters for wired network communications, and 802.11a/b/g/n adapters for wireless network communications.

I/O interface adapter 260 implements user-oriented I/O through, for example, software drivers and computer hardware for controlling output to display devices such as display device 265 and audio output device 270 as well as user input from user input device 275 and audio input device 280. User input device 275 may include both a keyboard and a mouse. Some embodiments may include other user input devices such as speech interpreters, bar code scanners, text scanners, tablets, touch screens, and/or other forms of user input devices. Audio output 270 may include speakers or headphones and audio input device 280 may include a microphone or other device to capture sound.

The computer and components illustrated in FIG. 2 are for explanation, not for limitation. In other embodiments, embedded systems, PDAs, cell phones, BlackBerries® and other computing devices which can connect to a network may develop user profiles in virtual worlds. In other embodiments, modules to develop user profiles in virtual worlds may be implemented in hardware, firmware, or in state machines or may form a component of an operating system.

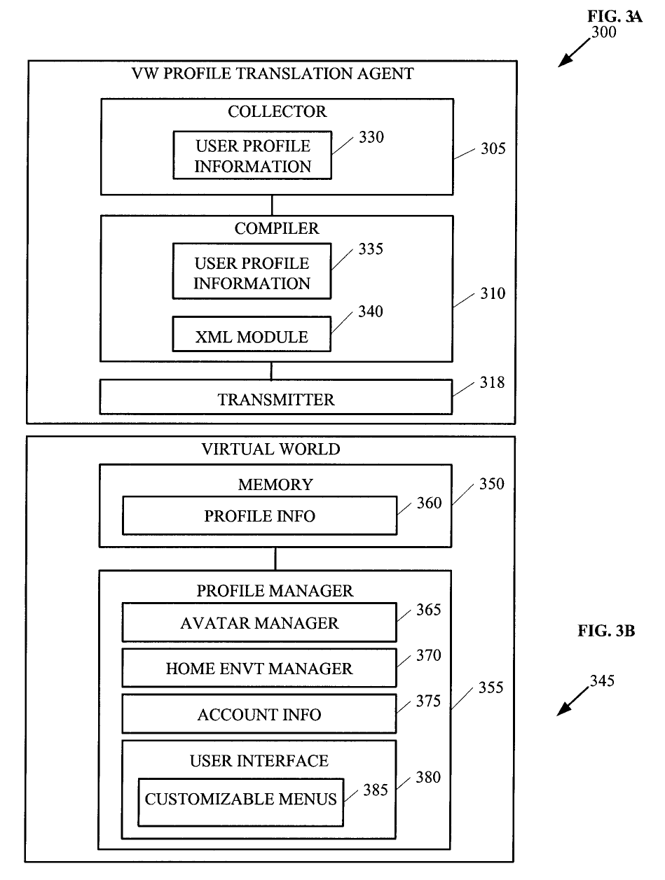

For further explanation, FIG. 3A sets forth a block diagram illustrating an exemplary apparatus 300 to automatically gather and formulate information for developing user profiles in virtual worlds. Virtual world profile translation agent 300 may obtain information from outside a virtual world and transmit the processed information to the virtual world or an intermediary such as a web service. Virtual world profile translation agent 300 includes collector 305, compiler 310, and transmitter 318.

Collector 305 may gather information from data stores external to a virtual world. Some data stores may contain account information or user profile information for other applications that may be useful for creating or modifying a user profile for the user in the virtual world. Many data stores may be contained on the user's local computer system, such as address books or lists of recent instant message contacts. Other data stores may be accessible over a network. For example, the source may consist of a user's friends' list in a social networking web site. In the embodiment of FIG. 3A, collector 305 stores the collected information in user profile information 330. Collector 305 may comprise a set of daemons or lightweight software agents installed on non-virtual world systems. In some embodiments, a software agent may run on a user's local computer system and may check for updates to information that is stored on the local computer system. In further embodiments, the software agent may include a menu to allow the user to specify the sources to be checked for information to be used to create or modify a user profile in a virtual world. The software agent may be synchronous, for example running at certain intervals, or may be event driven. In an event driven mode, software that houses a data source may have a hook or plug in into the software agent to initiate the collecting of information for use in locating objects in the virtual world. The software agent may be registered as a handler of the event. When an event in the data source occurs, such as adding information to the data source, the software housing the data source may pass control to the software agent. It may check for updates and may return control to the data store.

Compiler 310 may assemble the information collected by collector 305 and reformulate it into a uniform representation. Compiler 310 may perform the functions of the program compiler 214 from FIG. 2. Compiler 310 may run on the client side, perhaps on a user's computer system, or as a shared service provided by the virtual world provider. Although compiler 214 consists of software, compiler 310 may consist of software, hardware, or a combination of both. Compiler 310 includes user profile information 335 and XML module 340. User profile information module 335 may store the user profile information aggregated by compiler 310.

XML module 340 may create an XML document embodying the representation of the information gathered by collector 305. The XML document may, for example, contain tags to describe the information. The tags may include a specification of the fields of a data entry. For example, an address book entry may indicate a source of Outlook Express address book, and fields of email address, name, and home phone number. In some embodiments, XML module 340 may use a representation of the gathered information that may be useful in developing profiles in multiple virtual worlds.

Transmitter 318 may transmit the data produced by compiler 310 for use in creating or amending a user profile in a virtual world. In some embodiments, transmitter 318 may transmit the user profile information to the virtual world, a web service, or another intermediary. In some embodiments, a web service or other intermediary may translate the XML document into a document understandable by a target virtual world.

Turning to FIG. 3B, depicted is a block diagram illustrating a virtual world 345 capable of developing a user profile based on information automatically gathered from data stores external to the virtual world. Developing a user profile may include creating or modifying a user profile. Virtual world 345 includes memory 350 and profile manager 355. Memory 350 includes profile information 360, data used to create or modify user profiles. A portion of the information in profile information 360 may be based upon data aggregated by a module such as compiler 310 of FIG. 3A and transmitted to virtual world 345 by a transmitter such as transmitter 318. Portions of the information in profile information 360 may also be based upon information received from a user through user interface 380.

Profile manager 355 may create or modify a user profile in virtual world 345 based upon the information in profile information 360. Profile manager 355 includes avatar manager 365, home environment manager 370, account information 375, and user interface 380. Avatar manager 365 may generate or modify a user's avatar in virtual world 350. An avatar may consist of a two or three-dimensional graphical representation of a character of the user in the virtual world. Avatars come in many forms including depictions of real people, animes, and many other arbitrary forms. The virtual world may present avatars to the user with features based upon the user profile information received by the virtual world. The user may select one of the avatars presented, modify one of the avatars, or select another model entirely.

In some embodiments, the virtual world may offer to a user an avatar form, human, animal, or otherwise, similar to one the user has selected in another internet environment. In a few embodiments, the virtual world may base the avatar forms on the name of an existing avatar, or an account or profile name. As an example, a user with user name FuzzyBunny may be offered a very different starting avatar than that of a user with the name of WarriorKing. Once again, if multiple accounts exist, the user may chose an account on which to base an avatar, the user may simply chose to select a default avatar, or the user may create an avatar from scratch.

In addition to basing the initial avatar form on the automatically gathered data, the characteristics of the avatar could also be customized based on the user's legacy data. As an example, a human avatar may be rendered fitted with eyeglasses, or the user may be presented the option of using eyeglasses, in response to data indicating that the user has visited web sites related to eye glasses. Additional customization may be based on legacy data indicating such characteristics of an avatar as age, demographics, ethnicity, and other characteristics that may occur to those of skill in the art.

Home environment manager 370 may create a home environment for a user in virtual world 345 based upon profile information 360. The home environment may include the user's living quarters, clothes, furnishings and chattels, sound, and decorations. For example, home environment manager 370 may furnish the quarters of a user who shops online at Ikea with Ikea furniture, based upon information on the user's shopping habits gathered by a collector such as collector 305 of FIG. 3A. Similarly, home environment manager 370 may play background jazz for a user who frequently listens to jazz on a web radio.

Account information module 375 may maintain account information for registering a user in virtual world 345. The account information may include a name, user name, email address, physical address, avatar name, and other information used for registration. In virtual worlds that charge fees to users, the account information may include payment information.

User interface 380 may obtain information from a user for creating or modifying a user profile in virtual world 345. User interface 380 includes customizable menus 385. User interface 380 may tailor the process of obtaining profile information from a user to the data obtained from a data gatherer such as collector 305. The tailoring may include customizing menus presented to a user for gathering additional information. The customizable menus may omit fields for information already gathered. For example, once a user has been identified, virtual world 345 may already have obtained the user's real name, user name, email address and physical address. In presenting an interface to the user for gathering user profile information, user interface 380 may omit fields to obtain this data, or may include the data already filled in for verification. As another example, a customizable menu may base choices presented to a user upon information received from an information gatherer, as with the avatar choices discussed in paragraphs 0038 and 0039, above.

The modules of FIGS. 3A and 3B are for illustration and not limitation. An apparatus for developing user profiles in virtual worlds in accordance with embodiments of the invention may omit some of the modules shown, may include additional modules, or may contain different arrangements of modules. In other embodiments, some of the functions of a virtual world profile translation agent and a virtual world may be differently divided, or may be contained in other modules, as may occur to those of skill in the art. In some embodiments, a gatherer of information for use in developing a user profile may be contained in a virtual world client. In a few embodiments, a user interface may be contained in a local software agent or in an intermediate module such as a web service. In these embodiments, the user interface may receive from the user a specification of the data stores from which to gather information to develop a user profile in a virtual world or virtual worlds. The data stores may be specific to a particular virtual world or be used for a group of virtual worlds.

A compiler may create a representation in formats other than XML. The formats may include extensions of XML, such as XBase, XLink, XInclude, XSL (Extensible Stylesheet Language), XSLT (Extensible Stylesheet Language Transformations), XPointer, XML Query, and SOAP (Simple Object Access Protocol). The formats may also include non-XML formats, such as straight text.

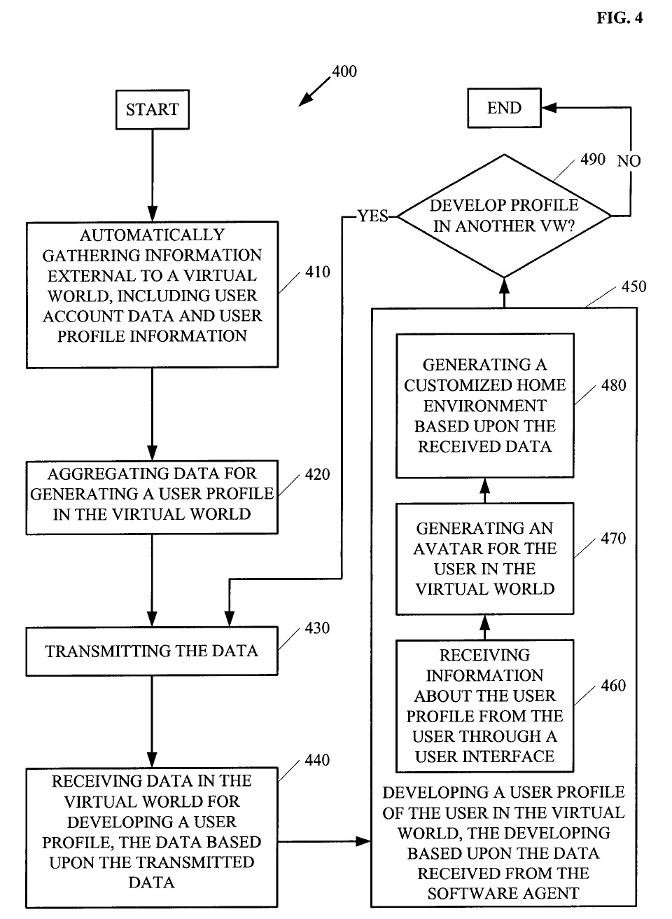

FIG. 4 depicts a flowchart 400 of an embodiment of a method to develop a user profile in a virtual world. In some embodiments, elements 410 through 430 of flowchart 400 may be performed by an apparatus such as virtual world profile translation agent 300 of FIG. 3A, and elements 440 through 490 may be performed by an apparatus such as virtual world 345 of FIG. 3B. Flowchart 400 of FIG. 4 begins with automatically gathering information from data sources external to the virtual world for registering and creating a user profile in the virtual world (element 410). The information may include any information useful to managing a user account in the virtual world, including user account data and user profile information. The sources of the information may include web history; profile information from other virtual worlds, blogs, and other web sites; account information such as email address and user name; spider history, and cookie information. In some embodiments, the user may specify the sources of the information, such as the user accounts and profiles from which data should be collected. The gathering may be performed by a daemon or lightweight software agent installed on a local computer device, which may search through data stores on the local computing device. The gathering may be periodic or event-driven.

The method may include aggregating the information into data for generating or otherwise developing a user profile in the virtual world (element 420). The aggregating may include combining entries from a variety of sources into a uniform representation, such as an XML document that contains profile information for a user. It may also include eliminating duplication. For example, both an address book and a friends' list in a social networking site may contain an entry for the same friend. The method may include transmitting the data (element 430), either directly to the virtual world or to an intermediate module such as a web service. The data could be aggregated into a single document, could be made into hybrid profile grouping common data, or could form multiple independent files.

The method may include receiving data in the virtual world for developing a user profile, the data based upon the transmitted data (element 440). The data may be received from the collector of the data, or from an intermediate source such as a web service. In some embodiments, the transmission may occur in connection with the user's interaction with the virtual world. For example, as the user enters a virtual world website and connects to a virtual world login page, the virtual world may detect the presence of a virtual world profile translation agent. The detection may occur through a probe, metadata associated with the login ID, or some similar method. The virtual world profile translation agent server agent may connect to the virtual world profile translation agent profile translation agent. In some further embodiments, the connection may be through a web service. In many further embodiments, the virtual world profile translation agent may be a component of the virtual world client system. The data may then be transmitted to the virtual world. In some embodiments, a document containing the entire data may be transmitted to the virtual world. In other embodiments, the virtual world client may retain the document, and the virtual world may interrogate the client about the contents. The client may then transmit responses to the virtual world.

The method may include developing a user profile of the user in the virtual world, based upon the data received from the software agent or intermediary (element 450). Developing a user profile may include registering a user in the virtual world, thereby creating a new user profile; or modifying an existing user profile. The user profile may be composed of account information about the user and user preferences for the environment of the virtual world. In the embodiment of FIG. 4, developing the user profile may include receiving information about the user profile from the user through a user interface (element 460). In some embodiments, the interaction through the user interface may occur during the virtual world registration process. The user may accept data presented by the virtual world based on the transmitted data or may choose to enter some of the data manually. In further embodiments, the user may create multiple profiles. The interaction may include prompting the user with proposed data for a user profile and asking the user in which profile to include the data. In many embodiments, only items that are free of charge would be offered to a user. For example, in some virtual worlds, a new user may receive a minimal home quarters free of charge, but may be required to pay for more deluxe housing. In some of these virtual worlds, the automatic registration process may only present the user with the free housing options. As another example, in some virtual worlds, basic avatars may be free, but more elaborate avatars may be fee based. In some of those virtual worlds, only basic avatars may be presented to the user. In other virtual worlds, the interaction between virtual world and user to register the world may include both the free options and the for-fee items.

The user interface may present specialized or customized menus to the user based upon the received data. In some embodiments, the user would be provided with automated selection menus and default avatar choices based on existing profile data. For example, the customized menus may automatically fill in some fields based upon the previous menus. In addition, they may tailor the requests for information based upon the preferences of the user. A user interested in sports may be asked for a favorite sport, a favorite team, and favorite players; while a user interested in music might be asked for a favorite type of music, favorite performers, favorite composers, and favorite artists.

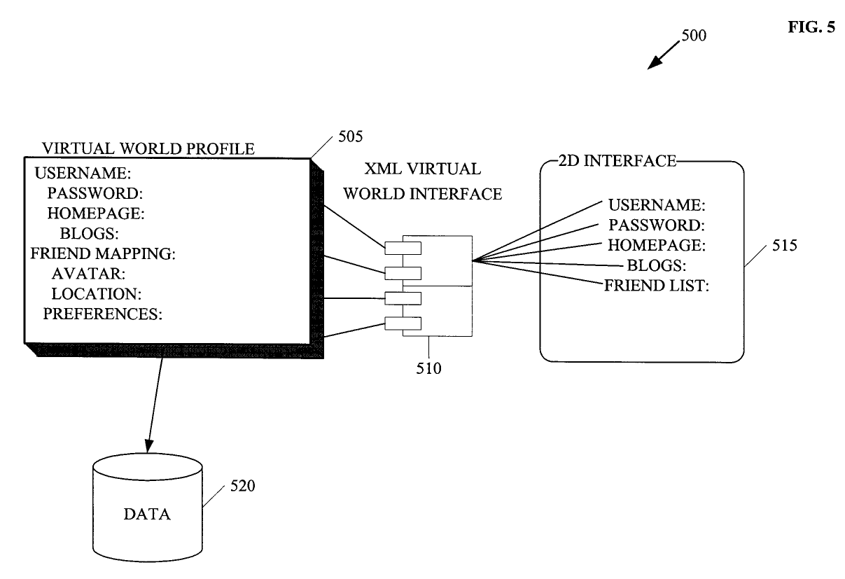

Turning to FIG. 5, shown is an embodiment of the data structures 500 to develop a user profile on the basis of automatically gathered information. The data structures include a record 505 of profile data for a single user, an XML representation 510 of data received from a gatherer, information entered by the user through a two-dimensional user interface 515, and a data base 520 of all user profile data for the virtual world. In the embodiment of FIG. 5, a virtual world may create a tentative virtual world profile of a user 505 based upon the data in an XML document 510 containing automatically gathered information. The virtual world may present to the user the tentative values for fields in the user profile in the two-dimensional user interface 515. The user may accept the data or enter alternative data. The user-approved and user-entered data are incorporated into virtual world profile 505. At the completion of the registration process, the data for the user profile may be stored in data 520, a storage of all of the user profiles in the virtual world.

Returning to FIG. 4, developing the user profile may also include generating an avatar for the user in the virtual world (element 470). The virtual world may present avatars to the user with features based upon the user profile information received by the virtual world. The user may select one of the avatars presented, modify one of the avatars, or select another model entirely. Developing the user profile may also include generating a customized home environment based upon the received data (element 480). The home environment may include dwelling, furnishings and other chattels, decorations, and sounds. If the user wishes to develop a profile in another virtual world (element 490), the elements from 440 through 480 may be repeated. Otherwise, the method of FIG. 4 may end.

The elements of flowchart 400 are for illustration and not for limitation. In alternative embodiments, additional elements may be included, some of the elements of flowchart 400 may be omitted, or the elements may be performed in a different order. In some embodiments, developing the user profile based on automatically gathered information may not include generating an avatar or generating a customized home environment. In many embodiments, automatically gathering the information may include receiving from a user a specification of sources for the information. In a few embodiments, the automatically gathered information may be used to develop user profiles for a user in several virtual worlds or several user profiles in a single virtual world.

The method of FIG. 4 may simplify a user's initial registration in a virtual world. A virtual world registration interface may collect and translate a user's current non-virtual world accounts and profile information, thereby enrolling the user without the need for the user to create profile data from scratch for each virtual world. The user would not have to duplicate the user's effort in entering the profile data in other accounts. In some cases, the virtual world registration interface may use the information to create a new avatar and/or customized virtual world environments for the new user. The virtual world registration interface may also provide the user with automated selection menus and default avatar choices based on existing profile data. As a result, the method of FIG. 4 may help to break down barriers for new users wishing to access a virtual world for the first time, and for users of one virtual world wishing to join a different virtual world. By automating a portion of the process of profile creation, the method may simplify the process, making it more likely that a potential new user would actually complete the registration process. The method may thereby cause an increase in the number of virtual users and may enable the virtual world community to tap into an established market of existing computerized users who may otherwise be hesitant to join a virtual world. Furthermore, the simplification of creation of a user profile may provide competitive advantages for a virtual world provider. In addition, the method may also allow for broader collaboration between virtual worlds.

Furthermore, the automated customization of such environments may aid a user inexperienced in virtual worlds in setting up a new personalized space. The method of FIG. 4 may provide an intelligent front-end to the registration process for a plurality of virtual world environments by providing a simplified and automated method for registration and entry. In some embodiments, the profile information of a user in an existing environment may be translated into a standard format, such as XML, and automatically introduced into a virtual world account in another virtual world.

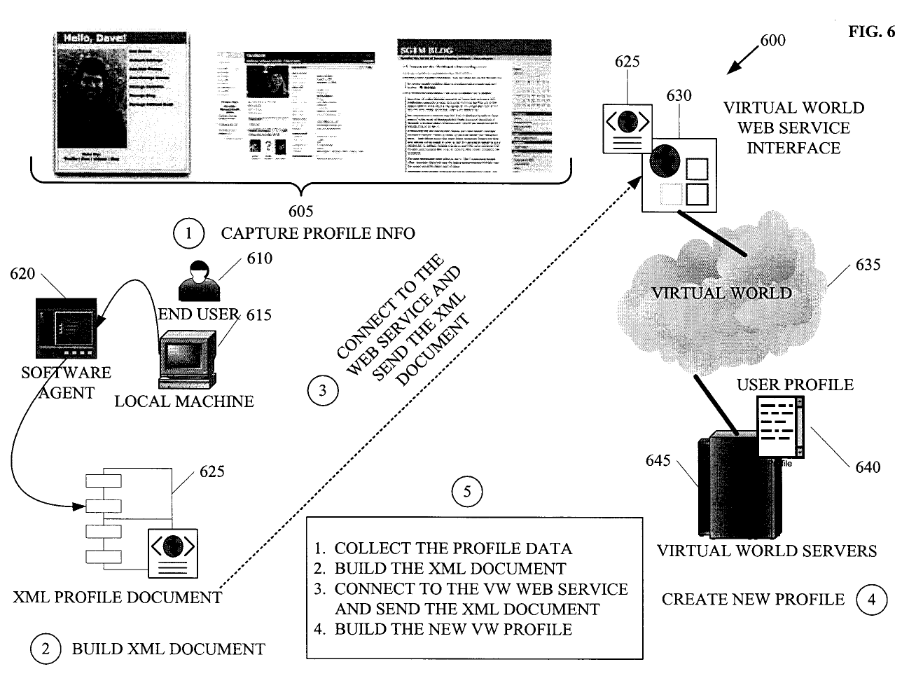

FIG. 6 depicts an embodiment of a data flow 600 to develop a user profile in a virtual world 635 on the basis of automatically gathered information. FIG. 6 includes the data structures (605, 625, and 640), the agents used to process the data structures (610, 615, 620, 630, 635, and 645), and a description of the process (represented by circled numbers, designated as elements). The data flow 600 includes capturing data from profile information 605 (element 1). The profile information 605 may include account information entered into applications other than the virtual world 635 application, such as name, email address, physical address, and user name entered into an email program or an instant message program. The profile information 605 may also include profile information entered into web applications other than virtual world 635, such as other virtual world programs, social networking web sites, and other web sites. The profile information 605 may be stored on local machine 615 in the form of cookies, spider history, or local storage of client programs used for accessing the web sites. A software agent 620 may capture the data from data entered into local machine 615 by end-user 610.

The data flow 600 includes building XML document 625 (element 2). The software agent 620 may use a uniform representation which may also be used for other virtual worlds. The data flow 600 includes connecting to virtual world web service interface 630 and transmitting XML document 625 to the virtual world web service interface 630 (element 3). In some embodiments, virtual world web service interface 630 may perform intermediate processing, such as translating XML document 625 into a representation usable by virtual world 635. In other embodiments, virtual world web service interface 630 may merely serve as a convenient relay between software agent 620 and virtual world 635, receiving XML document 625 and transmitting it with little or no change to virtual world 635.

The data flow includes the creation of new user profile 640 (element 4) by virtual world servers 645. New user profile 640 may utilize the information contained in XML document 625, which in turn may utilize profile information 605. Portions of new user profile 640 may have been automatically gathered by software agent 620 from profile information 605 without the need for manual entry by end-user 610 into virtual world 635. Element 5 of FIG. 6 is a summary of data flow 600.

The agents and data structures of FIG. 6 are for explanation, not for limitation. In other embodiments, a software agent may capture profile information from web sources that are not stored on a local machine. In many embodiments, the captured data may be aggregated into a format other than XML, such as plain text. In several embodiments, the transmission of the profile document may include several intermediaries or may omit any intermediaries. In many embodiments, an agent other than a web service may act as an intermediary. In a few embodiments, developing a user profile may include modifying an existing user profile on a virtual world rather than creating a new user profile.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product for developing user profiles in virtual worlds, the computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present invention contemplates methods and arrangements for developing user profiles in virtual worlds. It is understood that the form of the invention shown and described in the detailed description and the drawings are to be taken merely as examples. It is intended that the following claims be interpreted broadly to embrace all the variations of the example embodiments disclosed.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of developing a user profile for a user in a virtual world, the method comprising:
automatically gathering information from data stores external to the virtual world, the information comprising user account data and user profile information;
aggregating data for developing the user profile in the virtual world, the data based upon the information; and
transmitting the aggregated data directly or indirectly to the virtual world.

2. The method of claim 1, wherein automatically gathering information from data stores comprises gathering information from one or more of the following types of data sources:
web history;
cookies;
social networking websites;
user names and passwords;
other user account information; and
spider history.

3. The method of claim 1, wherein the gathering, the aggregating, and the transmitting comprise gathering, aggregating, and transmitting by a local computer of the user.

4. A method of developing a user profile for a user in a virtual world, the method comprising:
receiving data in a virtual world from a software agent directly or indirectly, the data based upon information automatically gathered from data stores outside the virtual world, the information comprising account data and user profile data of the user; and
developing a user profile of the user in the virtual world, the developing based upon the data received from the software agent.

5. The method of claim 4, wherein the developing comprises:
receiving information about the user profile from the user through a user interface; and
developing a user profile based upon the received information.

6. The method of claim 5, wherein the receiving information through a user interface comprises:
creating a user interface with specialized menus, the specialized menus based upon the received data; and
receiving information about the user profile from the user through the specialized menus.

7. The method of claim 4, wherein the developing comprises generating an avatar for the user in the virtual world.

8. The method of claim 4, wherein the developing comprises generating a customized home environment for the user in the virtual world, the customized home environment based upon the received data.

9. An apparatus to develop a user profile for a user in a virtual world, the apparatus comprising:
a receiver to receive data in the virtual world from a software agent directly or indirectly, the data based upon information automatically gathered from data stores outside the virtual world, the information comprising account data and user profile data of the user; and
a profile manager to develop a user profile of the user in the virtual world, the developing based upon the data received from the software agent.

10. The apparatus of claim 9, the apparatus comprising a user interface to receive information about the user profile from the user; wherein the profile manager is to develop the user profile based upon the received information.

11. The apparatus of claim 10, wherein the user interface comprises specialized menus, the specialized menus based upon the data received by the receiver; the specialized menus to receive from the user information about the user profile.

12. The apparatus of claim 9, wherein the receiver and the profile manager comprise a receiver and a profile manager contained within the virtual world.

13. The apparatus of claim 9, wherein the profile manager comprises an avatar manager to generate an avatar for the user in the virtual world.

14. The apparatus of claim 9, wherein the creator comprises an environment manager to generate a customized home environment for the user in the virtual world, the customized home environment based upon the received data.

15. A computer program product to develop a user profile for a user in a virtual world, the computer program product comprising a computer useable medium having a computer readable program, wherein the computer readable program when executed on a computer causes the computer to:
receive data in the virtual world directly or indirectly from a software agent, the data based upon information automatically gathered from data stores outside the virtual world, the information comprising account data and user profile data of the user; and
develop a user profile of the user in the virtual world, the developing based upon the data received from the software agent.

16. The computer program product of claim 15, wherein the computer readable program when executed on a computer causes the computer to:
automatically gather information from data stores external to the virtual world, the information comprising user account data and user profile information;
aggregate data for developing the user profile in the virtual world, the data based upon the information; and
transmit the aggregated data directly or indirectly to the virtual world.

17. The computer program product of claim 15, wherein the computer readable program which causes the computer to develop a user profile comprises a computer readable program which causes the computer to:
receive information about the user profile from the user through a user interface; and
develop a user profile based upon the received information.

18. The computer program product of claim 17, wherein the computer readable program which causes the computer to the receive information through a user interface comprises a computer readable program which causes the computer to:
create a user interface with specialized menus, the menus based upon the received data; and
receive information about the user profile from the user through the specialized menus.

19. The computer program product of claim 15, wherein the computer readable program which causes the computer to develop a user profile comprises a computer readable program which causes the computer to generate an avatar for the user in the virtual world.

20. The computer program product of claim 15, wherein the computer useable medium comprises a transmission medium.
